(19) United States
(12) Patent Application Publication
(10) Pub. No.: US 2011/0289781 A1
(43) Pub. Date: Dec. 1, 2011

(54) Child's Paper Trimmer Device

(76) Inventor: John R. Devecka, Calabasas, CA (US)

(21) Appl. No.: 13/115,201

(22) Filed: May 25, 2011

Related U.S. Application Data
(60) Provisional application No. 61/348,103, filed on May 25, 2010.

(51) Int. Cl. B26B 27/00

(52) U.S. Cl. 30/123; 30/165; 30/320

(57) ABSTRACT

A child safe paper trimmer device is utilizable by children and those lacking hand eye coordination or hand strength to conveniently utilize typical scissors arrangements. A child safe cutting blade is rotatably mounted so that it can be moved in any direction across a work surface, such as paper, to make a desired cut. A variety of mounting and tethering approaches are also described.

The present application claims the benefit of U.S. Provisional Application Ser. No. 61/348,103, filed May 25, 2010, which is incorporated by reference herein in its entirety.

### FIELD OF THE INVENTION

The present invention relates to a child safe precision paper trimming device, which trims in all directions when moved and contains a micro-trimming blade that is generally safe to the touch. The trimming device and system is specifically designed to allow children with limited motor skills to safely and independently trim material such as paper unsupervised. This device and approach of the invention may be utilized and have advantages for users of any age.

### BACKGROUND OF THE INVENTION

Products like “Islice”, and Scotch's Precision Cutter utilize fixed ceramic or other types of micro blades to provide a safe trimming blade for adults. The form factors and ergonomics are designed for adults and they have fixed blades that cut in one direction. Cutting complex patterns can be very difficult since they require significant twisting and turning of the wrist and advanced hand and eye coordination to cut such patterns. These products also do not provide a safe backing surface to trim on, so these cutters can damage a table or cut paper underneath the top page if a special subsurface is not used. They also do not restrict use of the device to a special backing surface.

Other products like Fiskars' precision cutters offer a handheld cutting blade that rotates in the direction of travel for use by adults mainly for scrap booking and other such activities. However, this product utilizes cutting blades that can be dangerous to children, does not provide a backing surface or illuminate the trimming area. These blades also may need replacement when they become dull, unlike ceramic and other micro blades.

Presently young children can trim paper and material with safety scissors or mechanical trimmers such as Crayola's Paper Cutter. These devices also have inherent limitations. Precision trimming is very difficult with safety scissors. It is also impossible to trim small shapes in the middle of the paper. Crayola's Paper Cutter utilizes a battery operated vibrating pen with a pointed tip to trim paper which is expensive, noisy and can damage other surfaces if a child puts the tip on a table, for example.

### SUMMARY OF THE INVENTION

None of the above approaches or technologies provides a safe, simple and precise trimming system for children to trim paper in an unsupervised environment. Among its several aspects, one goal of the invention is to provide users the ability to make very small and precise cuts directly in the center of material to be cut. The invention also provides a lighted guide in the area surrounding the trimming blade in order to assist a user achieve a further level of precision. The light can be utilized in fun light related art activities such as exposing special illuminating ink patterns and the like. Further, in a presently preferred embodiment, a special backing surface is provided, which may also be illuminated. The backing surface will secure the paper and prevent damage by the micro blade to other surfaces, such as a desk top, a kitchen table, or the like. The trimming device may also be tethered or mounted to the backing surface to ensure that the child only uses the trimming device on the recommended surface.

In addition, the backing surface can be made of a material that allows optimal gliding of the micro trimming blade to ensure ease of use by reducing drag, and that helps maintain the micro blade sharpness, so that the trimmer produces clean precise cuts and is void of tears and wrinkles. The backing surface should secure the paper via a clamping mechanism or system such that the child is not required to hold the paper while moving the trimmer, eliminating another level of difficulty. To ensure compliance by young children in using the proper backing surface in combination with the trimmer device, the trimmer may be tethered to the backing surface in a variety of ways, for example, with a cord, an X/Y track, or with a reticulating arm mechanism.

The present invention may suitably employ ceramic or other safe to touch micro-blades to ensure a child does cut himself or herself. Many additional novel features may be employed to allow a child to easily, safely and precisely trim paper and other material. Among its several advantages, the present invention may provide a safe, precise and cost effective paper trimming system available for young children, as well as, users of all ages that lack high levels of eye coordination or the hand strength to use ordinary scissors.

A more complete understanding of the present invention, as well as further features and advantages of the invention, will be apparent from the following Detailed Description and the accompanying drawings.

### BRIEF DESCRIPTION OF THE DRAWINGS

FIG. 1 shows a handheld pen shaped trimmer according to a first embodiment of the invention;

FIG. 2 shows a second embodiment of the present invention employing a hand guided roller ball supported pen movement device;

FIG. 3 shows a third embodiment of the present invention employing a protective cup arrangement in which the cutter is centrally mounted and isolated from a user's fingers when in use;

FIGS. 4A and 4B show top and side views of a blade arrangement for use in any of the embodiments of the present invention;

FIG. 5 shows an integrated arrangement of a trimmer tethered to a backing surface for supporting paper to be cut or trimmed, and; FIG. 6 shows an integrated arrangement of a cutter and an x- and y-track arrangement.

### DETAILED DESCRIPTION

While the present invention is disclosed in the context of several illustrative embodiments, it will be recognized that aspects of the teachings of the invention may be adapted to a wide variety of contexts in which children or those lacking the hand eye coordination or strength to effectively use scissors may want to do art projects, crafts, clip coupons, and the like.

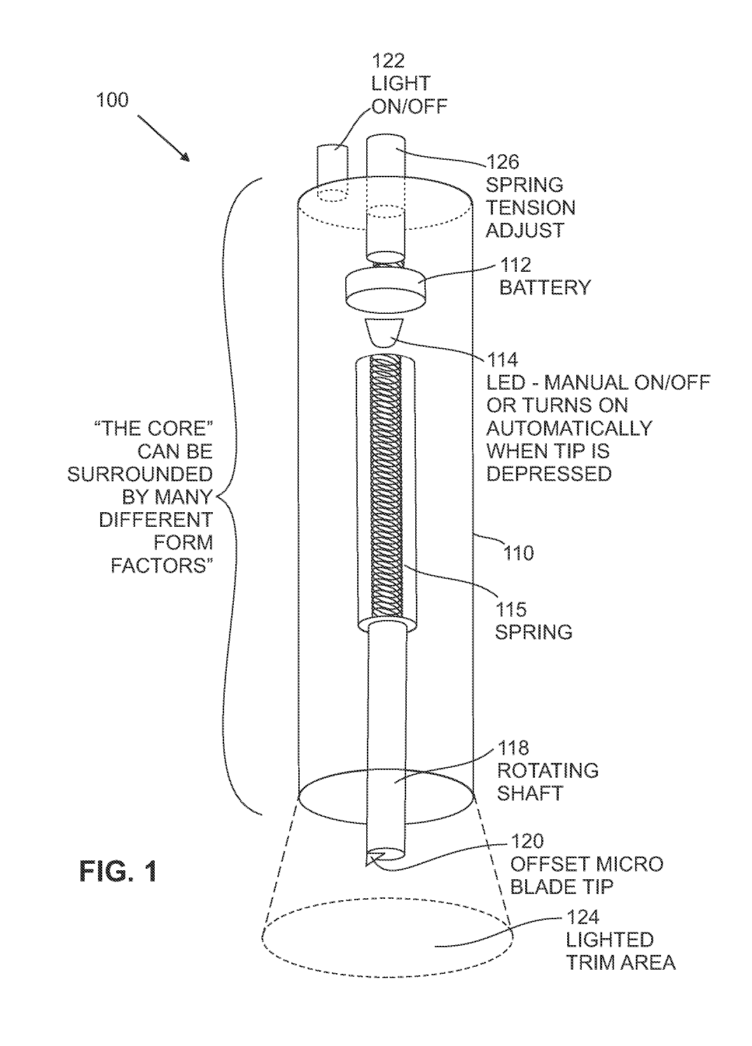

Turning to FIG. 1, a pen trimmer 100 in accordance with the present invention includes a pen-shaped body 110 enclosing a battery 112, an LED 114, a spring 115 and a shaft 118 rotatably supporting an offset micro blade tip 120 on its end. In some embodiments the micro blade length can be adjusted or the blade member can be easily removed and replaced with a longer or shorter blade to match the depth of the material that will be trimmed.

The rotating member can be made of a translucent material by which an LED or other light can placed above and directed down the rotating member and tip whereby light is providing precise illumination of the exact area of the paper that will be trimmed, greatly increasing the potential accuracy of the trim. The light could also be located on other areas of the housing. The LED light can be turned on manually or automatically activate when the trimmer is placed on the paper via a switch mechanism.

A spring loaded rotating member is preferred to provide the proper cutting pressure, however, the mirco blade shaft can be already calibrated to the proper pressure based on the distance of protrusion of the blade beyond the outer support housing. Thus, when the rotating member's spring compresses the ideal pressure is applied to the cutting tip. In addition, the blade could have a screw or other type extension means to adjust the blade member to have the appropriate pressure for the material to be cut. As seen in FIG. 1, button 122 is pressed to turn LED 114 on. When lighted, LED 114 illuminates a lighted trim area 124 so a user can see the work area, a pattern to be cutout, or the like. A second button 126 controls the adjustment of the spring tension of the spring 115.

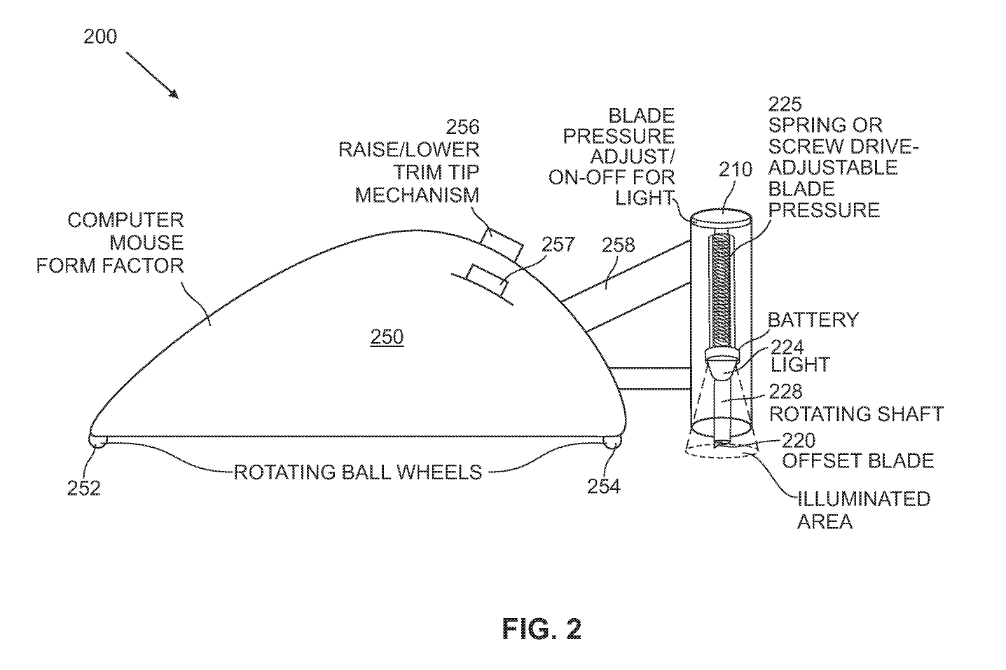

FIG. 2 illustrates an alternative embodiment 200 in which a pen trimmer 210 is integrated with a controller 250 which controls movement of the pen trimmer 210 including the raising and lowering of an offset micro blade tip 220. As seen in FIG. 2, controller 250 has a form factor similar to that of a computer mouse so that it will be highly familiar to most users. The body of controller 250 is supported by rotating balls or wheels 252 and 254 and a button mechanism 256 controls the raising and lowering of an arm 258 to lower the pen trimmer 210 to a work surface or raise it up above that surface.

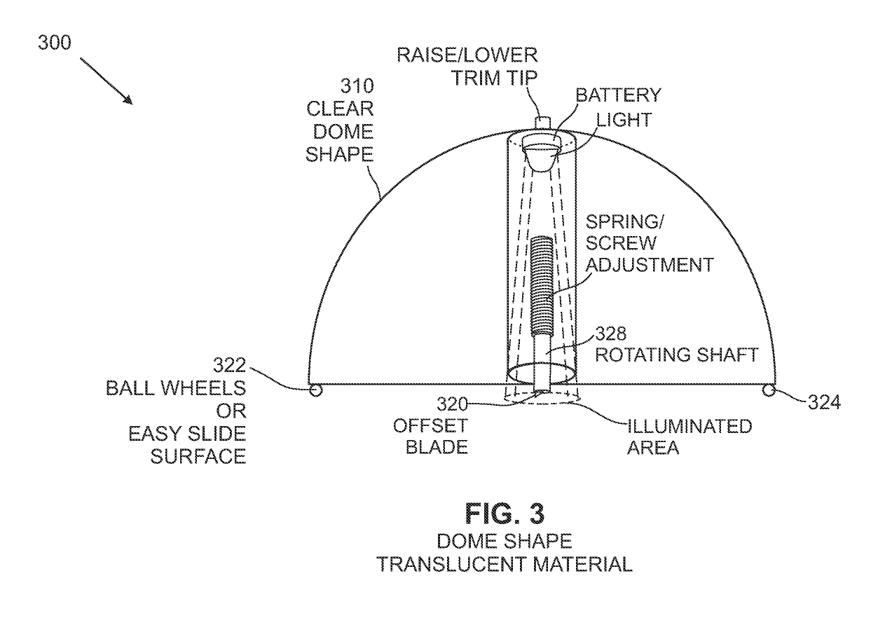

FIG. 3 illustrates a further embodiment of a trimmer 300 in which a housing surrounds micro blade 320 and rotating member 320. Wheels 322 and 324 that support housing 310 rest on the paper or other item that will be trimmed. The outer housing 310 could have a weight equal to the force required to push the micro blade tip into the paper. This weight will allow a child to simply push or roll the trimmer 300. Such an approach eliminates or reduces the effort of having to push the housing down and roll or slide the trimmer to have a firm enough contact to trim the paper.

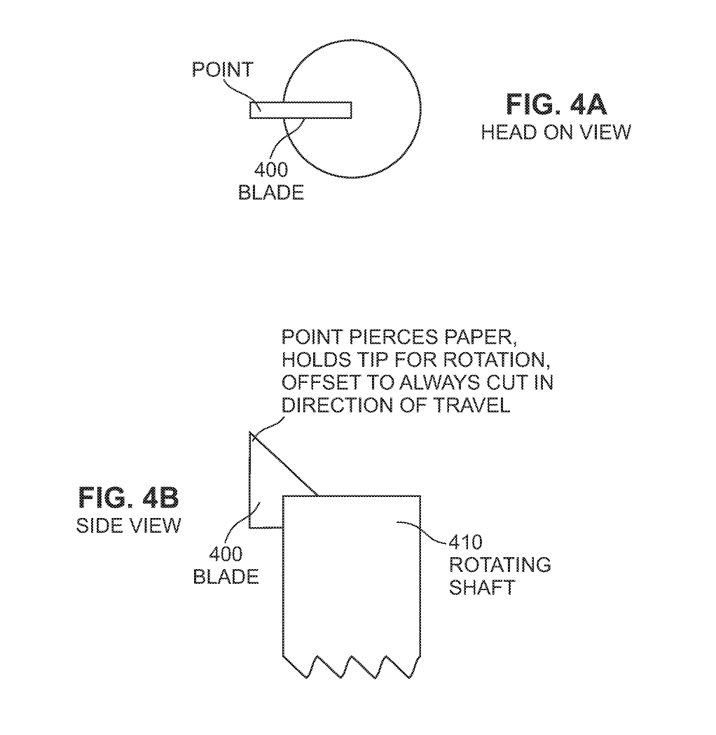

FIGS. 4A and 4B illustrate aspects of trimmer blade 400. Rather than attach the micro-blade 400 to a fixed surface, the micro-blade is attached to a rotating member 410 to allow the blade to trim in any direction of travel similar to rotating shopping cart wheels, which are typically the front wheels.

An optional double-sided blade or other blade configuration can be utilized in the event the blade fails to rotate in the direction of travel. The preferred method is to offset the micro blade tip on the rotating member to ensure the blade and member rotate the trimming edge of the blade after it makes contact with paper following the movement of the housing.

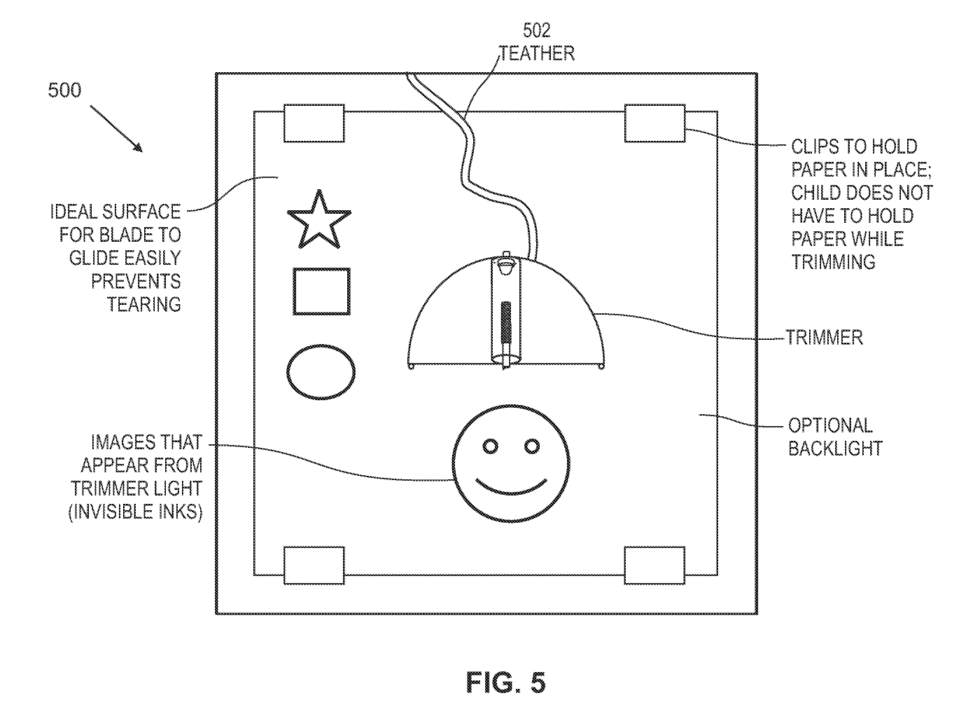

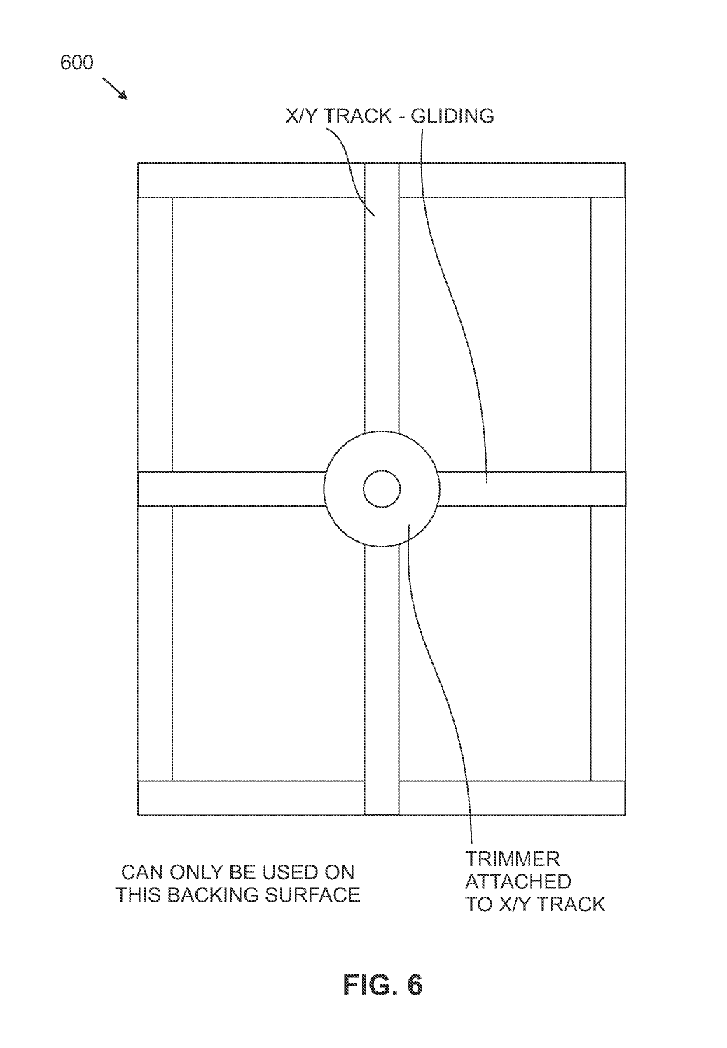

A tether 502 may be utilized as illustrated in the integrated unit 500 of FIG. 5. Alternatively, a sliding X/Y rack 600 may be mounted to a backing surface. In this case, only the rotary trimmer member would need to be in contact with a work surface, such as paper. Support and gliding are facilitated by the mechanical rack 600.

The rotary member may move up and down via adjustable or fixed spring tension providing additional pressure to the cutting surface and allowing the blade to contact the paper more firmly for thicker paper as an example. The blade depth may also be adjusted or the micro-blade member can be easily removable in order to insert a longer or different micro blade for thicker material or other purposes.

The outer housing can have many different form factors to improve ergonomics and ease of use for children with small hands. The outer translucent housing could also contain magnifying properties, or have a magnifier attached to it, which will enlarge the trim line. As addressed above, the outer housing can be in a shape that is held between a child's thumb and forefinger (FIG. 1) or can be in a computer mouse-type shape (FIG. 2) with the trimmer extending in front of the mouse to allow a clear view of the cutting pattern and the housing to be held and moved by the entire hand. The form factor could also be in the form of a pen with an internal rotating micro blade. It is important that the design allow an unobstructed view of the trimming tip and an area of the paper around it in order to see the marked line that will be trimmed. The housing should be made of a material that can slide easily on paper or fabric and may contain wheels or rotating bearings to ensure effortless sliding and trimming.

While the present invention has been disclosed in the context of various aspects of presently preferred embodiments, it will be recognized that the invention may be suitably applied to other environments consistent with the claims which follow.

I claim:

1. A trimmer device comprising:
a rotatably mounted micro trimmer tip having a touch safe blade; and
a housing supporting the rotatably mounted micro trimmer tip.

2. The trimmer device of claim 1 further comprising an LED light source to selectively light a trim line.

3. The trimmer device of claim 2 wherein said light source is directed through a rotating trim core.

4. The trimmer device of claim 1 wherein the micro trimming tip is positioned partially off the center axis of the housing.

5. The trimmer device of claim 1 wherein the micro trimming tip has a tension adjustment.

6. The trimmer device of claim 1 wherein the micro trimming tip is replaceable.

7. The trimmer device of claim 1 wherein the micro trimming tip has a length adjustment mechanism.

8. The trimmer device of claim 1 further comprising a backing surface.

9. The trimmer device of claim 8 wherein the backing surface further comprises material holders.

10. The trimmer device of claim 1 wherein the trimmer device is attached to a backing surface.

11. The trimmer device of claim 10 wherein the trimmer device is attached by a tether.

12. The trimmer device of claim 10 wherein the backing surface comprises an XY rack in which the trimmer device is slidably mounted.

13. The trimmer device of claim 10 wherein the trimmer device is attached by a reticulating arm.

14. The trimmer device of claim 1 wherein the trimmer device is supported by a controller unit having the form factor of a mouse.

15. The trimmer device of claim 1 wherein the trimmer device is mounted within a semi enclosed housing that supports the rotating trimmer.
